(19) United States
(12) Patent Application Publication
(10) Pub. No.: US 2013/0155694 A1
(43) Pub. Date: Jun. 20, 2013

(54) Recessed Lighting Enclosure and Insulation Barrier

(71) Applicant: David S. Hanacek, Capistrano, CA (US)

(72) Inventor: David S. Hanacek, Capistrano, CA (US)

(21) Appl. No.: 13/738,142

(22) Filed: Jan. 10, 2013

Related U.S. Application Data
(63) Continuation-in-part of application No. 13/116,904, filed on May 26, 2011.
(60) Provisional application No. 61/402,112, filed on Aug. 24, 2010.
(60) Provisional application No. 61/396,428, filed on May 27, 2010.
(60) Provisional application No. 61/688,325, filed on May 11, 2012.
(60) Provisional application No. 61/631,832, filed on Jan. 11, 2012.

(30) Foreign Application Priority Data
May 25, 2012 (CA) 2777945

(51) Int. Cl. F21V 15/01; F21V 29/00; F21V 17/00

(52) U.S. Cl. CPC F21V 15/01; F21V 17/00; F21V 29/002
USPC 362/364; 29/428; 29/525.01

(57) ABSTRACT

A recessed lighting enclosure comprises a housing having an open bottom, at least first and second side walls, a tapered roof, and an opening in the roof. The roof opening can optionally be covered with a flap, and is preferably overhung by an eve. The housing can be made of a cardboard or other foldable or readily cut panel, internally lined with fiberglass or other insulation. The insulation can advantageously extend below the bottom of the panel. Panels can be manufactured and shipped in a flattened shipping configuration. Assembly can use chemical, mechanical, or any other suitable mechanical connectors. Once installed, mats, bats, blown or any other type of insulation can be disposed about the housing.

This application claims the benefit of priority to Canadian Application Serial No. 2777945, filed on May 25, 2012, and is a continuation in part of U.S. patent application Ser. No. 13/116,904, filed on May 26, 2011, which claims priority to U.S. Provisional Patent Application Ser. No. 61/402,112, filed on Aug. 24, 2010 and U.S. Provisional Patent Application Ser. No. 61/396,428, filed on May 27, 2010. This application also claims priority to U.S. Provisional Patent Application Ser. No. 61/688,325, filed on May 14, 2012 and U.S. Provisional Patent Application Ser. No. 61/631,832, filed on Jan. 11, 2012. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTIVE SUBJECT MATTER

The field of the inventive subject matter is recessed lighting enclosures.

### BACKGROUND

Weatherization and energy conservation have become a national priority and the proper insulation of attics, and consequently recessed light fixtures, is one of the best ways of improving heating and cooling efficiency and saving energy. Past and current solutions for insulating light fixtures address the barrier requirements around the fixture, but fail to solve the problem of heat loss above the fixture. Worse still, with the barrier and the insulation in place around the fixture, the heat source creates a chimney effect which draws air from the area below and greatly reduces the overall insulation efficiency.

Examples of previous solutions can be found in U.S. Pat. No. 2,648,764 to Kirlin, U.S. Pat. No. 4,237,671 to Munson, U.S. Pat. No. 4,375,142 to McDonald, U.S. Pat. No. 4,400,766 to Munson, U.S. Pat. No. 4,754,377 to Wenman, U.S. Pat. No. 6,079,856 to Prestier, and U.S. Pat. No. 6,286,980 to Meyer.

Enclosures utilizing traditional vents and/or louver openings, such as U.S. Pat. No. 6,286,980, address barrier functions, but fail to adequately address the balance between energy efficient insulation and dangerous entrapped heat buildup. Simply stated, insulation is a heat and cold trapping material and therefore a vent that is covered with insulation for the purpose of insulating is effectively blocked and creates a trapped heat buildup danger. To be functioning vents and avoid potentially hazardous heat levels, these openings must be uncovered rather than blocked. The trade off is a safer un-insulated energy wasting application or a potentially dangerous insulated one.

Enclosures such as the use of clay flower pots placed over the light fixtures are also fraught with shortcomings and pose an extreme weight danger risk and the potential of clay pots falling through the ceiling, particularly in seismic areas. Pot shaped type covers constructed of mineral fiber or other fire resistant materials are lightweight, but also trap potentially dangerous levels of heat.

Thus, there is still a need for a recessed lighting enclosure that limits heat loss and cold penetration through the ceiling, while allowing for managed air circulation to guard against hazardous levels of trapped heat buildup.

### SUMMARY OF THE INVENTION

The inventive subject matter provides apparatus, systems and methods in which a housing has an open bottom, at least first and second side walls, and a tapered roof. In some embodiments the housing additionally includes an opening in the roof.

In one aspect of some embodiments, the bottom is completely open, although in less preferred embodiments the bottom can be only partially open.

In another aspect of some embodiments, the housing is substantially rectangular, or even square in horizontal cross-section. Other shapes are contemplated, especially those with polygonal cross-sections, but a rectangular shape is currently thought to provide the greatest volume of air horizontally surrounding the lighting can. A square housing, for example, is thought to provide about 21% more air space horizontally about a lighting can than a corresponding cylindrically shaped housing. In most preferred embodiments, the edges of the housing are beveled. The sides can optionally have air holes.

In yet other aspects of preferred embodiments, the roof is continuous with each of the side walls, and is folded to provide the eve(s) mentioned above. It is contemplated that the roof can have one or more openings, and more than one eve portion. The roof opening(s) can optionally be covered with a Mylar™ or other flap, or a mesh (not shown). Alternatively, the roof openings could be sufficiently small that they need no covering at all to prevent blown insulation from entering the housing through the openings.

The housing can be made of any suitable material or materials, including insulation. In especially preferred embodiments, at least one of the walls has a cardboard or other paper-containing panel, which is internally lined with a sheet of insulation material. Such sheets can advantageously extend at least 0.4 inches (about 1 cm) farther down the first side than the panel, and can advantageously include a bottom cutout for wires to pass though the wall.

From a method perspective, a ceiling can be insulated by: providing a housing having an insulated first side, an open bottom, and a tapered roof; placing the housing over the can such that the first side is at least 2.5 inches, and more preferably at least 3 inches, from the can; and ensuring that the roof has at least a first opening for egress of hot air.

Preferred methods further include ensuring that the roof has an overhang over the first opening. During installation, all portions of the housing are preferably distanced at least 3″ from the can, a bottom portion of at least the first side wall is folded back, and where the ceiling can is disposed near a joist, the folded back bottom portion to the joist using a fastener. Tie strips are also contemplated for holding the housing in place. Where the ceiling can is powered by a wire from outside the housing, it is contemplated to run the wire through a passage in one of the side walls, preferably near the bottom of the side.

One or more openings can be pre-punched, preformed or otherwise disposed in the roof, and in some embodiments it is contemplated that an installer would punch out one or more such openings.

The housing is preferably manufactured and shipped in a flattened shipping configuration, which is assembled into a roofed box configuration at an end-user location. Assembly can use chemical, mechanical, or any other suitable mechanical connectors, as for example magnetic. Once installed, mats, bats, blown or any other type of insulation can be disposed about housing.

In general, the inventive subject matter is contemplated to provide a much-needed improvement for insulating around and above potential fire hazard heat sources. Without wishing to be limited to any particular theory or mechanism of action, it is contemplated that embodiments claimed herein utilize compartmentalization and the principle of hot air rises and cold air falls, to better direct, restrict, manage, and control (hot/cold) airflow and desired temperature. Preferred embodiments are thought to restrict cold air penetration, while providing means for dangerous heat source elevated temperatures to diffuse and/or escape. In the roof, one or more converging diagonal panels are thought to reduce the upper internal area, thus reducing the external exposure area.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of an assembled housing.

FIG. 2 is a perspective view of the housing of FIG. 1, depicted in a flattened shipping configuration.

FIG. 3 is a perspective view of an alternative housing in which the roof has two vertical portions and two sloped portions.

FIG. 4 is a plan view of an opened, unassembled cross section of the housing of FIG. 3.

FIG. 5 is a perspective view of a partial assembly of the housing of FIG. 3.

FIG. 6 is a vertical cross section of the housing of FIG. 3, with optional baffle, as installed about a can light fixture and its associated electrical box and wiring.

FIG. 7 is a vertical cross section of the housing of FIG. 3, showing contemplated air flow.

FIG. 8 is a perspective view of an alternative housing.

FIG. 9A is a cut-away cross sectional views of a roof panel of the housing of FIG. 8, showing a diagonal deflection integral “baffle' opening.

FIG. 9B is a cut-away cross sectional view of the roof panel of FIG. 9A, in which the baffle opening is pushed more horizontally, and thereby allows more hot air to escape.

FIG. 9C is a cut-away cross sectional view of the roof panel of FIGS. 9A and 9B, but here showing an overlying flap.

FIG. 10 is a plan view of a cutout sheet of material that forms the walls and roof of the housing of FIG. 8.

FIG. 11 is a plan view of a large sheet of material that could be cut to produce multiple copies of the cutout sheet of FIG. 10.

FIG. 12 is a plan view of a die cut sheet of material that forms a panel, which can be folded and fastened to a similar sheet to form the housing of FIG. 13.

FIG. 13 is a perspective view of an assembled housing two panels of FIG. 12.

FIG. 14 is perspective view of yet another alternative housing, showing positioning of a housed lighting with a space created by the housing and the ceiling.

FIG. 15 is a side view of mating ratchet rivet parts.

FIG. 16 is a side view of Christmas tree type fastener parts

FIG. 17 is a side view of an arrow type fastener.

FIGS. 18a and 18b show a side view of the beveled edge 320 of housing 300 in FIG. 13.

FIG. 19 illustrates an embodiment of the inventive subject matter in the assembled configuration.

FIG. 20 illustrates an embodiment of the inventive subject matter in a partially folded configuration.

FIGS. 21a and 21b illustrate an embodiment of the inventive subject matter being reconfigured from a partially folded to open configuration ready for use.

FIG. 22 illustrates an embodiment of the inventive subject matter in a partially unfolded configuration.

FIGS. 23a and 23b illustrates an embodiment of the inventive subject matter in a flat, folded conformation ready for shipping and/or storage.

FIGS. 24a and 24b show views of production panels laid flat after manufacture and prior to folding for storage, shipping or use.

FIG. 25 illustrates a flat view of an embodiment of the inventive subject matter as it would be manufactured, prior to folding and final assembly.

FIG. 26 illustrates a perspective view of an embodiment of the inventive subject matter partially folded with the top panels not yet secured to each other.

FIG. 27 illustrates an assembled embodiment of the inventive subject matter. In this illustration the inventive subject matter does not include a vent.

FIG. 28 illustrates an embodiment of the inventive subject matter where the top panels converge to form a flat rather than pointed top.

FIG. 29 illustrates an embodiment of the inventive subject matter that is partially collapsed in preparation for shipping and/or storage.

FIG. 30 illustrates an embodiment of the inventive subject matter and depicts exemplary folding lines that have been scored to allow for partial separation of membrane and glass panel.

FIG. 31 illustrates an embodiment of the inventive subject matter where an internal cut runs partway to the edge to mitigate separation of the panel and membrane.

FIG. 32 illustrates an improved roller for use in the manufacture of embodiments of the inventive subject matter.

FIG. 33 illustrates a roller machine for use in the manufacture of embodiments of the inventive subject matter.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

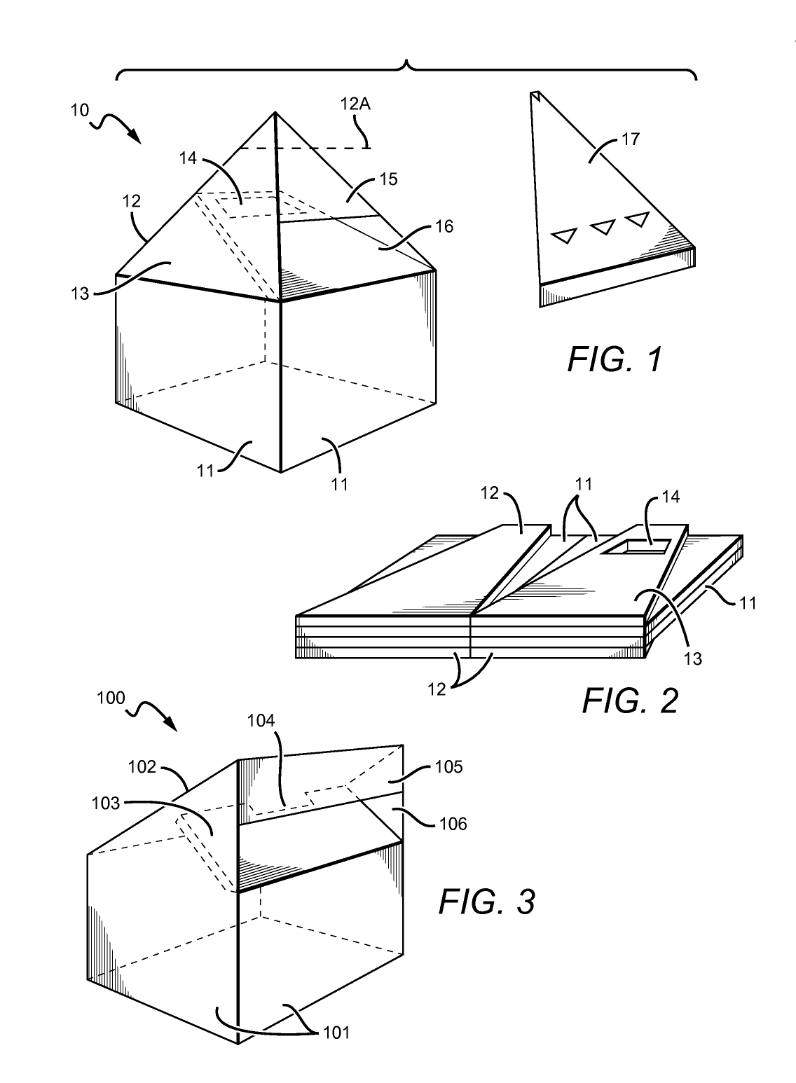

FIG. 1 shows an assembled housing 10 that provides an optional baffle to restrict and direct airflow, and a partially covered (enclosed) area with exposure to external air for the purpose of obtaining a controllable internal air temperature. FIG. 2 shows the same enclosure in a shipping configuration.

The housing of FIGS. 1-2 includes four sides walls 11, a roof comprising four sloped portions 12 and 13, which are continuous with the four sides walls 11, respectively, an opening 14 in roof portion 13, and an overhang (or eve) 15. Roof portion 13 and the overhang 15 cooperate to form the external exposure opening 16. There is an optional pull protective cover 17 that is intended to protect the external exposure opening 16 from blown insulation penetration. Line 12A is a maximum fill height caution marker. As used herein, the term “eve” refers to an overhang formed from, or extending directly from, a portion of a roof.

The housing of FIGS. 1-2 is substantially square in horizontal cross-section. Other shapes are contemplated, especially those with other polygonal cross-sections, but a rectangular shape is currently thought to provide the greatest volume of air horizontally surrounding the lighting can. In most preferred embodiments, the edges of the housing are beveled. Beveled housing edges are thought to increase strength of the housing, while only minimally reducing seal effectiveness. In addition, beveled corners allow the housing to fold into a relatively flat configuration with minimal compression and distorting of the insulation and housing materials and allows for the use of straight-cut internal panels, thus allowing for easier shipment. Furthermore, beveled edges reduce insulating and housing materials used, significantly lowering production costs and minimizing impact on the environment. The sides can have air holes (not shown), although such side holes are thought to be less desirable.

Each of the housings described herein can be made of any suitable material or materials. Contemplated materials for the walls include aluminum and/or other sheet metal, fire resistant cardboard, foiled cardboard, foiled foam board, gypsum board, mineral fiber, wire frame structure and rigid fiberglass. Such walls can be made of a single material, such as wallboard or gypsum that provide adequate insulation. Alternatively or additionally, one or more of the walls can be constructed of a paper or other panel lined with one or more sheets or mats of fiberglass or other insulation material. Foiled rigid fiberglass may have advantages such as; fire resistance, insulating, strength, durability, partial flexibility, manufacturing labor savings and workability. Those features are considered particularly helpful during on-site fitment and installation around obstacles such as wires, fixture housing brackets and framing members.

Thus, the housings of FIGS. 1, 3, 4, 6, 7 and 8 should all be interpreted as including myriad possible options, including a first option that each of the walls and roof portions comprises a paper, wire or other skeleton to which fiberglass or other insulating mats are attached on an inwardly facing side, and a second option in which each of the walls and roof portions comprises fiberglass or other insulating mats that are sufficiently rigid to form the housing without relying on any supporting skeleton.

Each of the housings described herein are also contemplated to have open bottoms. As used herein, the term “open bottom” means at least 70% open. Thus, a housing having a bottom sheet with a large central hole would still be considered to be an open bottom housing as long as the area of the hole is less than 30% of the area that could be occupied by the bottom sheet. Nevertheless, it is preferred that the bottom of the housings are completely open, i.e., there is substantially no extension of the side walls towards the center of the bottom of the housing.

FIGS. 3, 5, 6, and 7 show an alternate housing 100 in which two of the roof portions are vertical, and another two of the roof portions are sloped. Here there are four sides walls 101, a roof comprising two sloped portions 102 and 103, which are continuous with two of the side walls 101, respectively, an opening 104 above roof portion 103, and an overhang (or eve) 105. Roof portion 103 and overhang 105 cooperate to form the external exposure opening 106.

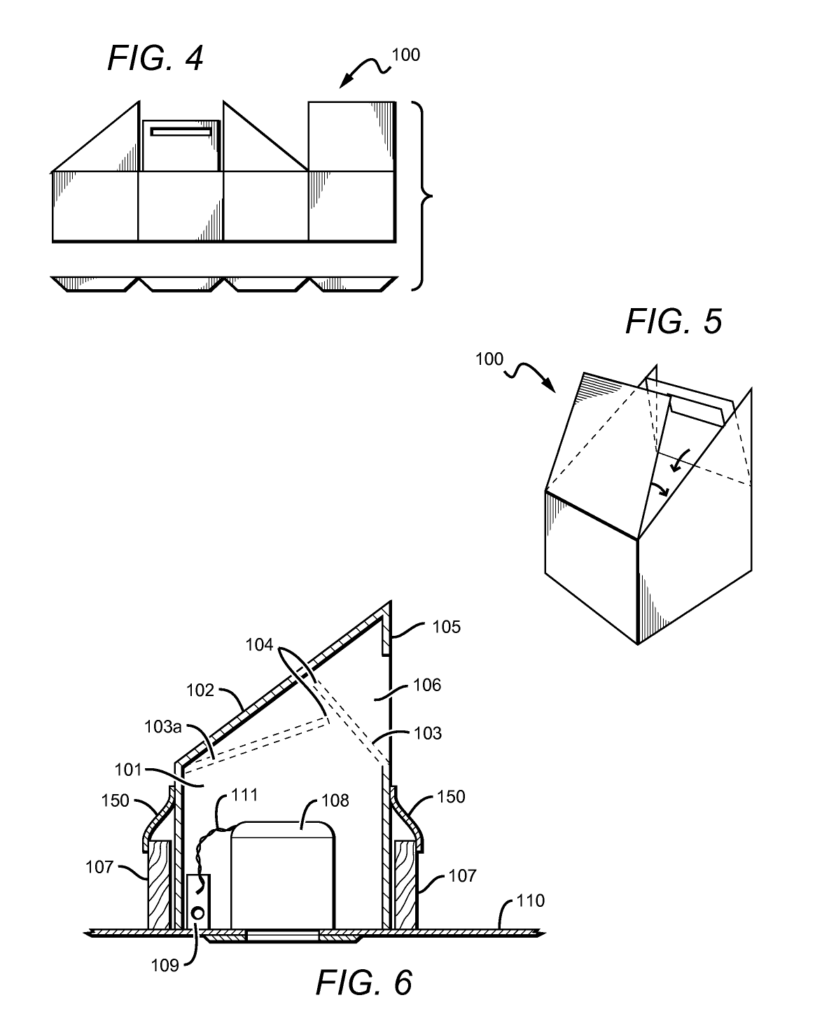

FIG. 4 shows the same enclosure in an opened configuration, such as could be seen during manufacture.

FIG. 5 shows the same enclosure in a partially assembled configuration. Roof side portions 102 and 103 have not yet been brought into juxtaposing contact.

FIG. 6 shows the same enclosure with an optional baffle 103A, and also depicts two joists 107, the portion of a lighting can 108 that extends above the ceiling 110, an electrical box 109, and wiring 111. FIG. 6 further shows tie downs 150, which should be viewed as being stapled or otherwise attached to the joists 107. Similar tie downs can be added to any of the other housings contemplated herein.

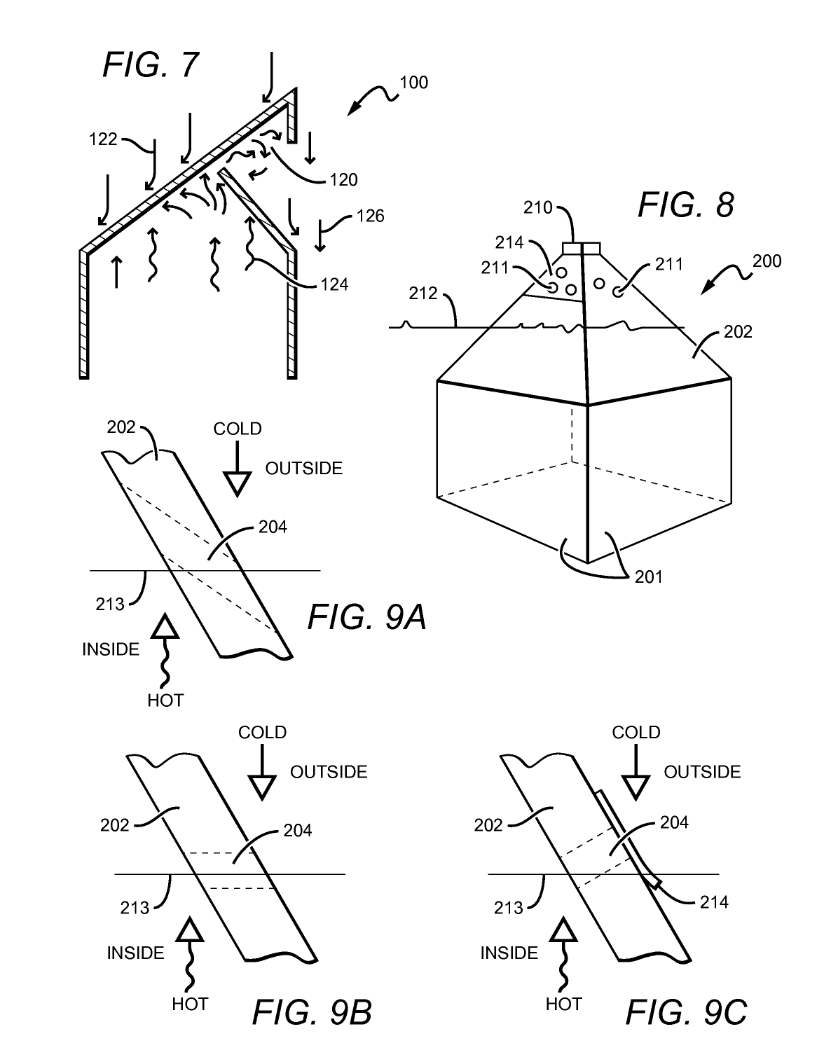

FIG. 7 is a vertical cross section of the housing of FIG. 3, showing contemplated air flows 120, 122, 124, and 126.

FIG. 8 is a perspective view of an alternative housing 200, once again having four walls 201, and here having four sloped roof portions 202, roof openings 211, Mylar™ or other heat activated membrane cover 214, and an optional cap/cover and retainer 210 capable of holding/retaining loose insulation, the top of which is depicted by line 212.

Components exposed to potentially cold air are insulated and can be sloped to prevent cold penetration. A sloping top directs heat/cold and greatly reduces the surface area (when properly covered with insulation) exposed to external temperature conditions. FIG. 8 combines an inward sloping top and one or more vent openings 211. Hot/cold can be further managed via the use of a heat-activated membrane cover 214 (which in this case is a flap), which covers the openings 211 until sufficient heat buildup causes lifting the flap, thus allowing heat to escape.

FIGS. 9A, 9B, and 9C illustrate venting through dimensional insulating material of roof portion 202. It is contemplated that air flow can be managed and directed by opening size, orientation angle, quantity, etc. or any combination thereof. For example, FIG. 9A illustrates a diagonal opening 204 that functions as a baffle and provides more ‘restrictive’ venting management than 9B or 9C. Principle dynamics that hot air rises and cold air falls are used to manage, direct, and regulate the rate of heat/cold loss and gain. Control also can be achieved by use of at least one opening and/or baffle panel and the desired effect can be achieved by combination of materials, slope, opening size and configuration. For example, a flat baffle panel with a small air escape opening will entrap greater heat than a sloped baffle that allows heat to more freely travel upward and escape. Likewise, the final “air mixing” chamber can control heat/cold, by means as simple as reducing the opening size, or by sloping an ‘exit” panel to limit the escape of hot air and the penetration of cold.

FIG. 9C shows that hot air flow lifts (opens) the heat activated membrane cover 214 until temperature stabilizes. Level line 213 is shown for reference.

Contemplated housings can be in a kit form of separate parts, “pre-hinged” parts that unfold for easy assembly, partially assembled components, fully assembled or any combination thereof. Final assembly can include the use of fasteners, tape or similar adhesives as well as connecting joinery and parts that secure the structure when assembled. Base and top can be integral parts or a combination of parts and materials. Guide lines and/or scored lines can be included as an aid for fitment; for example, when trimming for framing, wiring, and fixture of brackets. Square or rectangular configurations can provide greater internal air volume and thus a larger heat diffusion area; however, cylindrical configurations, hexagon and other shapes are acceptable, providing that clearance requirements from the heat source are met. Other embodiments can include collapsible frames covered with acceptable materials or assembled units, tapered to allow for nesting and reduce packing and shipping volume.

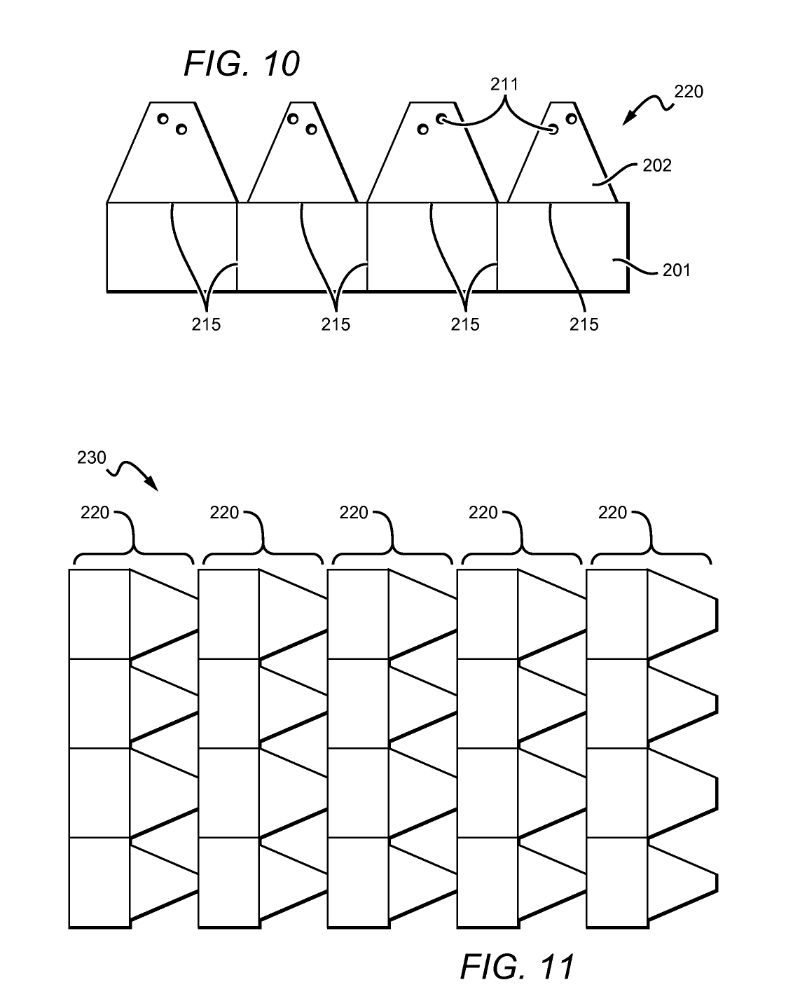

FIG. 10 is a plan view of a panel 220 of material that forms the walls and roof of the housing of FIG. 8. Fold lines are depicted with numeral 215. Panel 220 could be cut (stamped) and scored to allow for desired folding and assembly. When constructed of rigid foil faced (duct use type) fiberglass material, score lines 215 would leave foil surface intact to act as a connecting “hinge”. External strapping, fasteners or the like can be employed to complete the assembly. Currently, panels of cardboard are preferred because they are inexpensive to manufacture, lightweight, provide sufficient durability and rigidity, and form a casing to which mats of fiberglass can be attached in a relatively easy manner, using fasteners as described below. Where cardboard or other flammable materials are used as or in the panels, it is preferred that the panels have casing a spontaneous open air combustion temperature between 350° F. and 500° F. (about 177° C. and 260° C.), inclusive, more preferably at least 400° F. (about 204° C.) and most preferably at least 450° F. (about 232° C.).

FIG. 11 shows how a large sheet of material 230 could be cut to produce multiple copies of the panel 220 of FIG. 10.

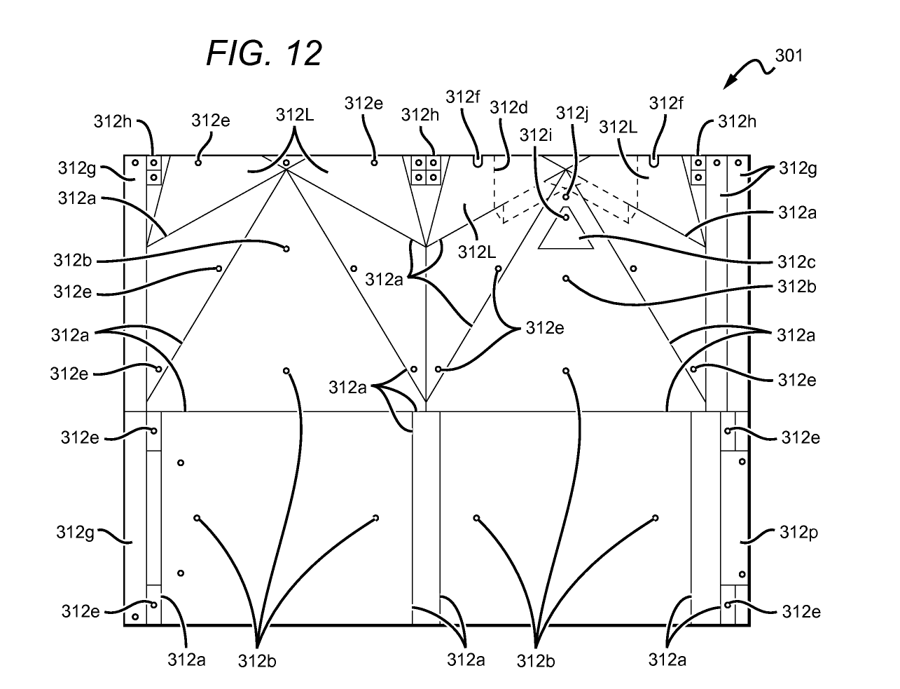

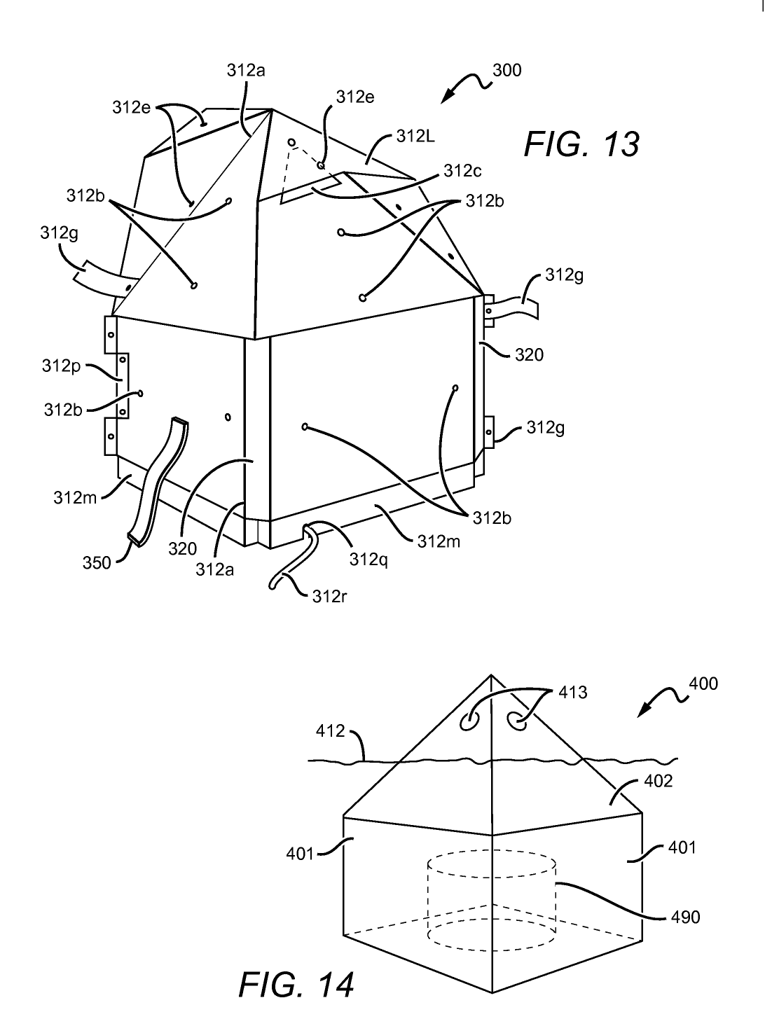

In FIG. 12 is a die cut cardboard or other foldable sheet material forming a panel 301, which can be folded and fastened to a similar panel 301 to configure housing 300 (See FIG. 13). Panel 301 has fold lines 312a, locating/fastening holes 312b for secure internal rigid fiberglass (or suitable material) to provide added support, fire resistance and insulation, a vent opening 312c, which could be punched out by an installer, optional perforations 312d wherein material is removed and folded in a manner to secure an insulating panel over the vent opening, fastening holes 312e, fastening slots 312f, optional straps 312g for securing the installed housing 300 to joist or other objects (not shown), optional washers 312h, an optional hole 312i for aiding removal of vent blocking material, useful when cover is removed after installation and/or surrounding with external insulation, and a hole 312j for attaching optional membrane cover (not shown).

In FIG. 13, the assembled housing further includes a vent cover area 312L created by folding/connecting panels 301, a fiberglass (or comparable) material attached to the inside of panel 301, with an extension portion 312m extending below the bottom edge of panel 301, which allows for better fitment around whatever fixture (not shown) is used to position the lighting can (not shown), and a securing tension flap 312p that can be fastened with arrow type clips (not shown) to create a tension resistant joint-seam capable of maintaining tight corner seams/connections and allowing internal panels to compress and better seal together without separating joint-seam. A tie down 350 is shown as being attached to a side wall of one of the panels 301.

Of especial interest here is that in this embodiment, the housing 300 has four walls with beveled edges 320, two of which are shown in the figure. Also of interest is that the extension portion 312m has a cutout 312q, which could be a hole, a tab, or simply a slot, through which a wire 312r could conveniently pass. Depending on the material(s) used in the walls, such holes, tabs or slots could be cut by an installer. In an alternative embodiment (not shown), the fiberglass (or comparable) material attached to the inside of the panel 301 could terminate flush or even within the wall.

In FIG. 14, yet another alternative housing 400, having walls 401, roof portions 402, and baffle vents 413. Inside the housing is the upper portion of a light can 490, shown in dotted lines. The lighting can 490 preferably has a closest distance to any of the walls 401 of at least 2.5 inches (approx 6.4 cm), and more preferably at least 3 inches (approx. 7.6 cm), or some other distance that satisfies a local ordinance or rule. Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

Here again, without wishing to be limited to any particular theory or mechanism of action, it is contemplated that the housing 400 is an advancement over prior art housings at least partially because the converging diagonal upper portions of the roof direct heat up to at least one opening, and also reduce the potential exposure area towards the uppermost terminating intersection(s).

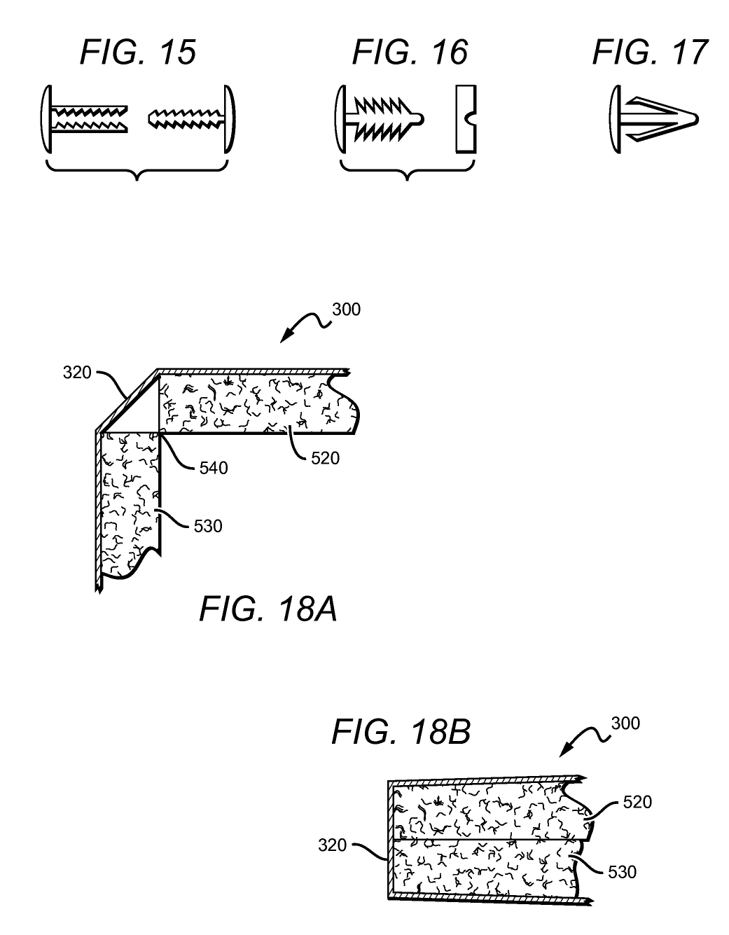

FIG. 15 is a side view of mating ratchet rivet parts for attaching sheets of a fiberglass or other material to panels of a housing, as in FIG. 13.

FIG. 16 is a side view of a Christmas tree type fastener and retaining nut for quick connection of panels of a housing to one another, as in FIG. 13.

FIG. 17 is a side view of an arrow type fastener for attaching an optional membrane (flap) over a vent opening 211, as in FIG. 8, and can also be used for securing tension flap 312p, as in FIG. 13.

FIGS. 18a and 18b show a side view of the beveled edge 320 of housing 300 in FIG. 13. Beveled edge 320 allows insulation layers 520 and 530 to fold into a relatively flat configuration (FIG. 18b) with little distorting of the insulating layers and housing material. When housing 300 is in an open configuration (FIG. 18a) insulation layers 520 and 530 meet at a joint 540 to form a sealed interior. One of skill in the art will appreciate that the length of beveled edge 320 and the thickness of insulation layers 520 and 530 can be varied to achieve different degrees of compression of the insulation layers at joint 540. The beveled edge provides a gap, which allows for repositioning and fitment modification when installing the housing. The gap further eliminates the need to trim at least one internal panel edge and allows for a more uniform and secure seal to joist material to prevent unwanted airflow and migration of surrounding insulation into the internal housing area and potentially living space.

It is contemplated that one could use different types of fasteners, box staples, or even glue or adhesive in place of any of the fasteners shown in FIGS. 15-17. Currently, however, the fasteners shown in FIGS. 15-17 are preferred because they are thought to be cost-effective, provide good long-term stability, have a relatively high failure temperature, and are environmentally friendly once in position. Many glues and adhesives, for example, can fail at about 200° F. (about 93° C.), and may produce off-gasses.

Additional safety devices/features protect against heat buildup. Housings can function without vent(s) covers, but in the event covers are employed and heat builds up to critical level, additional safety features could include one or more of the following: (1) A vent could be covered with a heat sensitive membrane that shrinks, (melts) at a predetermined temperature; (2) A desired material failure could be aided by including at least one focal point such as a hole that allows minimal passage of air, but would expand as heat reached critical levels and material shrinks; (3) A cover could be installed with low-temp failure adhesive and positioned to “fall” away from the roof opening.

From an installation standpoint, it is contemplated that a housing contemplated herein could be easily installed to retrofit either IC (insulation contacting) or non-IC fixtures. Steps would include: (1) providing a housing having an insulated first side wall, an open bottom, and a tapered roof; (2) placing the housing over the can such that the first side wall is at least 3″ from the can; and (3) ensuring that the roof has at least a first opening for egress of hot air. In preferred embodiments, steps would also include one or more of the following: ensuring that the roof has an overhang over the first opening; ensuring that all portions of the housing are at least 3″ from the can; and folding back a bottom portion of the first side wall. Where the ceiling can is disposed near a joist, contemplated methods include attaching one or more of the folded back bottom portion, or a tie strip, to the joist using a fastener. Where the ceiling can is powered by a wire, and the first side wall defines a passage, contemplated methods include running the wire through the passage.

It is further contemplated to distribute a blown type of insulation about the housing, or another other type of insulation such as blankets of fiberglass.

Contemplated production methods include stamping or cutting out panels form cardboard or other suitable material, as for example in FIGS. 4, 10, 11 and/or 12, folding them into housings, as for example in FIGS. 1, 3, 5, 6, 7, 8, 13 and/or 14, and using fasteners as for example in FIGS. 15, 16, and/or 17. It is especially contemplated to ship housings in a flattened shipping configuration, as for example in FIG. 2.

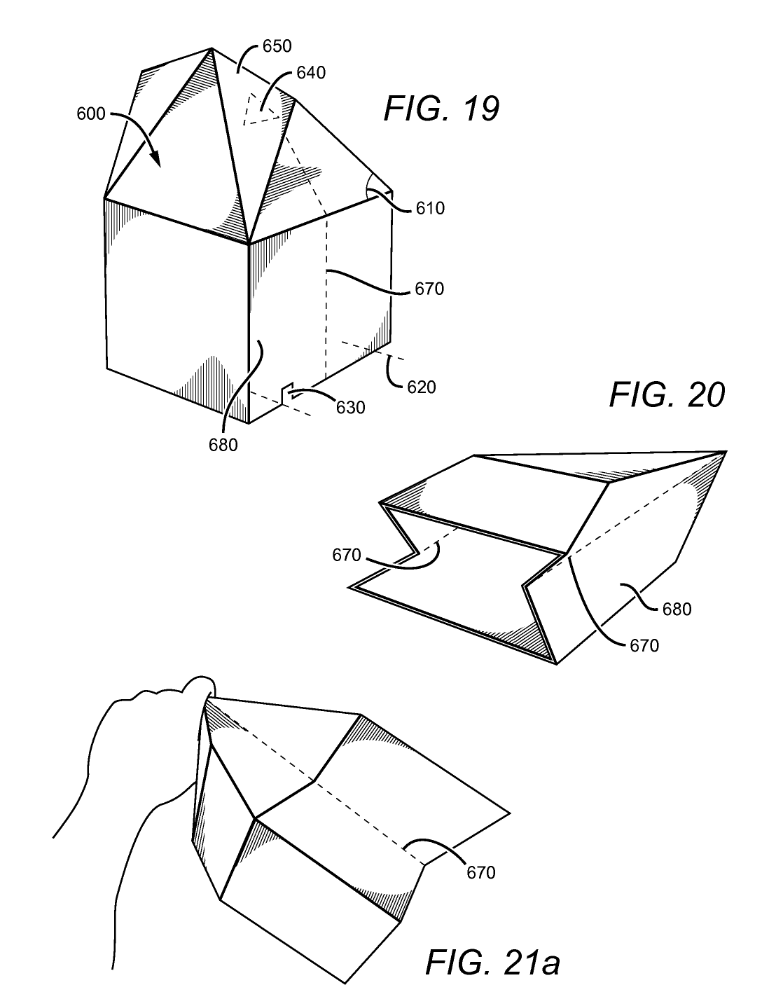

In other embodiments, the inventive subject matter includes additional features that permit greater pre-assembly prior to use, and/or permit use with fewer or no additional fasteners. In particular these embodiments provide for easy production of a complete ready-to-install housing from a folded or partially folded state. For example, FIG. 19 illustrates a housing that can be produced from a folded state. A roof portion 600, when folded past the vertical plane, imparts a tension on the seams of the housing to improve strength and sealing of seams. The degree of angle 610 can be varied in order to provide additional rigidity to the housing when in the assembled configuration.

Conveniently, the housing can be adapted to be installed on a light fixture bracket or track 620. In some embodiments the top portion may form an inclined or sloped surface as shown in FIG. 19, or a more flattened top (e.g., less angled) as shown in FIG. 28. In some embodiments slots 630 can be added to increase the rigidity and stability of a bottom fold.

In non-insulation contact applications, where some airflow is desired, one or more vents 640 can be included on each side of top portion 650 of the housing. However, when insulation is desirable (e.g., applications in which the housing is “insulation contacting”), the housing need not be cut with vents 640 and any vents may be considered optional.

FIGS. 20 and 22 show an embodiment of the inventive subject matter in a partially folded configuration. Folding is made easier by producing the housing with fold lines 670 disposed generally along a vertical axis of a side portion 680 of the housing. In effect the fold lines 670 permit the housing to be open and closed accordion style. In the closed, or flattened, configuration, the housing takes up significantly less space, providing an advantage for shipping or storage. Folding the housing after manufacture and prior to use also provides the advantage of affording some protection to the various surfaces of the housing to reduce the chance of accidental damage during shipping or storage.

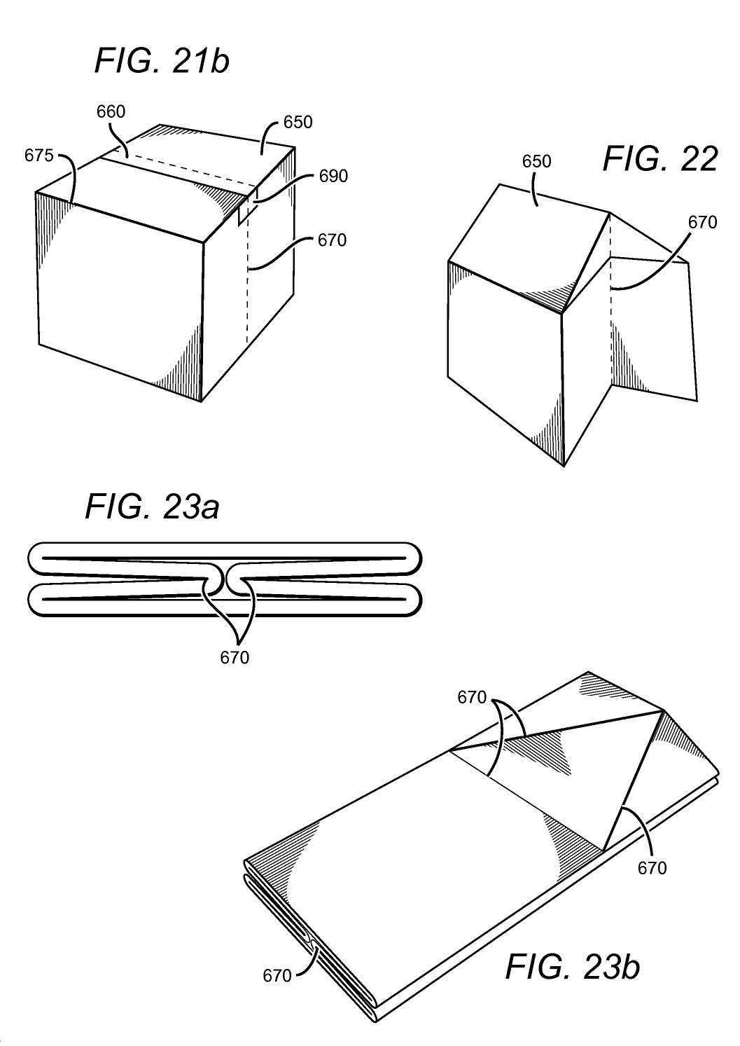

FIGS. 21a and 21b illustrate an embodiment in the partially unfolded and unfolded configurations respectively. In FIG. 21a, a user is shown using simple hand pressure to pop open the housing by simple unfolding. FIG. 21b illustrates a completely unfolded housing. In some embodiments adjacent top portions can be configured to fold at a hinge 675, and to overlap each other at an overlap region 660. Overlapping can also provide additional rigidity to the housing in its assembled state. Overlapping regions can also include lapping surfaces 690 that could further include well known features such as slots and tabs (not shown) to better secure a folded joint and to aid in resistance to movement.

FIGS. 23a and 23b illustrate embodiments of the inventive subject matter in a compact, folded configuration. The fold lines in this case are roughly diametrically opposed so that the structure folds substantially symmetrically upon itself. While two folds are illustrated here, more than two folds are compatible with the present inventive subject matter. For example, it might be desirable in some cases to have a plurality of folds so that the housing could be collapsed into a roughly tubular shape for shipping or storage. In addition, a tubular shape could be advantageous when replacing housings in round openings, or where openings of non-standard sizes or shapes are encountered.

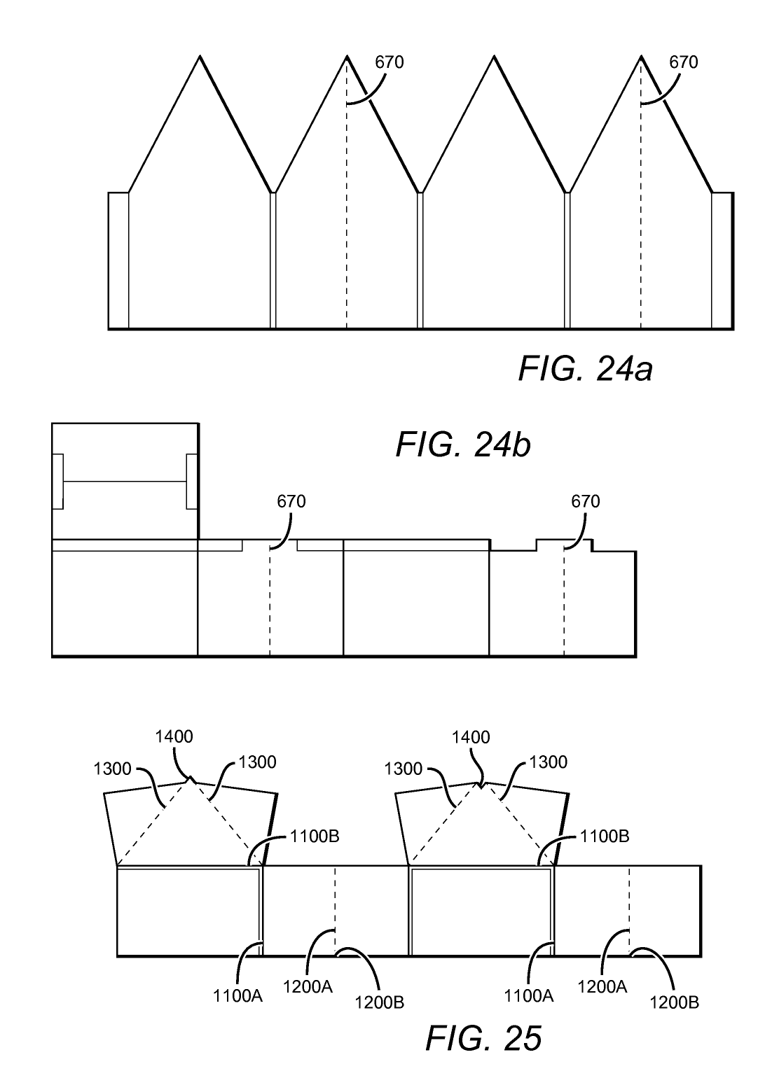

FIGS. 24a and 24b illustrate embodiments of the inventive subject matter as they are initially manufactured. It is contemplated that one method of manufacture could be to stamp, or die cut, panels out of rolls of material using a pre-made die. In some cases the die could stamp units from smaller panels of material. In other cases it might be preferable to use a roller die that cuts roll stock of the panel material fed past the roller, and then separate individual units in a subsequent cutting step from. Conveniently, and as shown in these Figures, a complete housing may be produced as a single piece from the desired material. The manufacturing die or stamp may also be designed to press in the fold-lines into the manufactured panel to aid in later assembly.

A variety of materials are compatible for use in the manufacture of the present inventive subject matter. For example, foil/scrim/kraft (FSK) would be suitable to provide ease of handling, sufficient structural strength, and desirable properties of heat and air penetration resistance. An attached and/or bonded material such as fiberglass, mineral fiber or other suitable material having desired properties of rigidity, compressibility and/or shape memory, could also be used to provide the features of structural rigidity as well as heat and air penetration properties.

FIGS. 25 through 31 illustrate embodiments of the present inventive subject matter that further include score cuts that function as hinge elements. For example in a housing manufactured from FSK, the score cuts 1100A and 1100B may penetrate the fiber but not the outer membrane of the material. In one embodiment, a housing constructed of ½″ to ⅝″ glass fiber material could include a ¼″ deep score cut 1100A to form a tensioned square corner, and ⅛″ deep score cut 1100B to form a tensioned folded seam along the sloped upper panels. These “hinges” would provide the desired folding characteristics and compression properties to the housing when in the assembled configuration.

Additional cuts and or folds 1200A are positioned to aid in folding of the housing for shipping and/or storage. As with the score cuts 1100A and 1100B, these cuts do not penetrate the outer membrane of the housing material. In addition, fold 1200A need not extend to the very bottom (i.e., edge) of the housing, as is shown in by non-folded area 1200B. This non folded region near the edge of the housing helps to prevent tear by eliminating a tear initiation point at the edge.

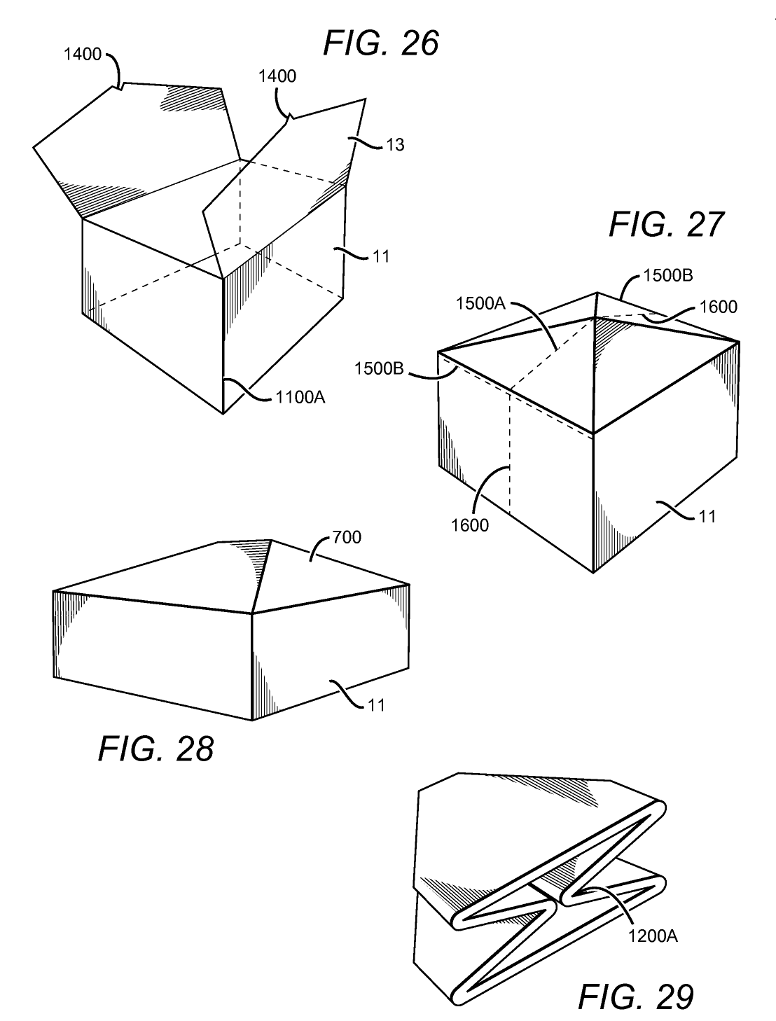

In some cases cuts 1300 could provide additional fold lines. Depending on the need for structural strength versus ease of folding, these score cuts could be run part of the length, or the entire length of the region into which they are cut. To assist in securing and placement of adjacent roof portions, a male-female tab-slot alignment feature 1400 is included at the point that will form the peak of the roof portion. FIG. 26 illustrates a partially folded housing where the side portions have been folded along the score cuts, and the roof portions are yet to be engaged with each other. The alignment feature 1400 is shown.

FIG. 27 illustrates an embodiment of the inventive subject matter where a vent has not been included in the roof portion. In this embodiment a fold line 1500A function as a top joining seam line. Fold lines 1600 are formed by score cuts shown earlier as 1200A.

FIG. 28 illustrates an embodiment wherein the roof panels 700 meet at a flat plan convergence, rather than at a peak or pointed junction. The roof panels can be fashioned according to overlap to whatever extent is required. Overlap of the roof panels will increase the rigidity of the housing. Additionally, tabs or other forms of securement may be fashioned into the adjacent roof panels so that they can engage each other, again improving the stability of the assembled housing.

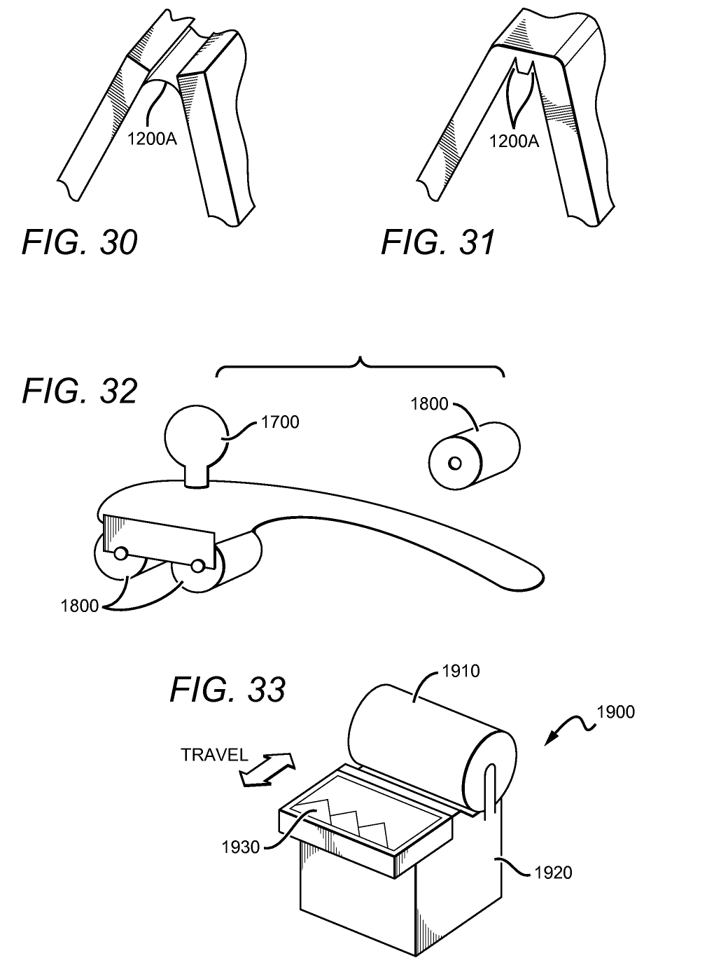

FIG. 29 illustrates an embodiment in a partially folded configuration. Fold lines 1200A provide a point along which the structurally will naturally tend to fold. Fold lines 1200A can be formed from score cuts that penetrate through the fiber (as in FIG. 30), but not the outer membrane, or can be partial cuts that either do not fully extend the length of the housing or do not fully penetrate the fiber portion of the material (as in FIG. 31). Where the cut is deeper, the fiber material may be separated.

The embodiments in FIGS. 30 and 31 show examples of a housing produced using a material with a fiber layer and outer membrane. In some cases it is possible for the housing to be formed from a homogenous material, in which case the score cuts would be interpreted to be extending to varying degree into, but not completely through that material. Those of skill in the art will readily appreciate the depth of a score cut required to provide the features of folding and hinging without unduly compromising the overall strength of the assembled housing will vary depending on the material, size, and configuration of the housing.

FIG. 32 illustrates a roller design useful in the production of score cuts in the material used to fashion the housing. FIG. 32 is an example of a radius roller 1800 that permits scoring while reducing the chance of damage to the surface of the material either side of the desired cut line. This tool can also be made multifunctional, and include such things as a scraper adapted to remove fiber from specific areas of the housing prior to final assembly. The roller may also include a top handle 1700 to improve ergonomic efficiency. The roller may also include a quick-change mechanism to allow easy replacement of an old roller with a new one 1800A.

FIG. 33 illustrates a roller machine 1900 for use in production of housings from stock material. The machine includes a roller 1910 based on a platform 1920. A cutting die 1930 represents the shape of the manufactured product. The stock from which the housings are to be cut could be provided either as sheets or rolls of material. The stock can be fed either manually, or by automated systems that are well known in the art of manufacturing processes. Secondary stripping can be performed during the return travel by way of a separating die board and actuated scraping device. Vacuum suction may be included to remove waste and to aid in cleaning the die surface prior to the next cutting operation. The die may include all the shape features of the housing, as well as any score cuts where those are used to provide fold and/or hinge lines. Pressing into the stock material would provide an alternative method to form fold lines, rather than cutting. The die may be movable in order to adjust the depth of the score cuts as may be desired for different applications or when working with different types of materials. The die can optionally be a plate as depicted, or may be disposed along the radius of the roller.

Embodiments of the inventive subject matter could conveniently be offered for sale either unassembled or partially assembled. Embodiments of the inventive subject matter could also be offered in a kit form, including for example, with a foldable cardboard or other type of form that mates with the interior dimensions of the device to aid in fast, accurate assembly of a housing.

The base design optimizes volume and facilitates fitting to standard 16″ on center framing joints. However, it is readily apparent that the design of the present inventive subject matter is adaptable such that any style of framing could be accommodated. In particular, the inventive subject matter is well adapted for use in tight spaces, such as near roof rafter pitches, or where the placement is near an eave. In addition, the angled top portion of the housing can be varied in position to adapt the housing for placement in tight attic spaces where room above the fixture is limited. Conveniently, the roof portion of the housing can be partially collapsed if desired without comprising the integrity of the rest of the housing.

The inventive subject matter provides an easy to use, stable barrier that provides the necessary separation between the fixture and the surrounding insulation. The design takes advantage of outside pressure exerted by the weight of the surrounding insulation to ensure tightness of seams and the base seal on the substrate, without the need for caulking, expanding foam, tapes, or other adhesives.

It should be appreciated that the numerous embodiments disclosed herein can be used or adapted for use with either IC light fixtures or non-IC light fixtures. The inventive subject matter is not intended to be limited by any particular category of light fixture. Depending on the application (e.g., type of light fixture, heat generated by the bulb, environmental temperatures, surrounding materials, etc) openings can be included in the barrier housing to achieve the desired barrier characteristics.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A housing comprising:
an open bottom when fully configured for use;
at least first and second side walls;
at least one of the side walls providing insulation with an R value of at least 0.1; and
a tapered roof.

2. The housing of claim 1, further comprising a first opening and wherein the roof comprises a first eve portion that overhangs the first opening.

3. The housing of claim 2, wherein the roof comprises a second eve portion that overhangs a second opening.

4. The housing of claim 1, further comprising the panel having third and fourth side walls, wherein the roof is continuous with at least three of the first, second, third, and fourth side walls.

5. The housing of claim 1, further comprising a beveled edge disposed between the first and second side walls.

6. The housing of claim 1, wherein the first side wall comprises (a) a panel and (b) a sheet of insulation inside the panel, having an R-value of at least 0.25

7. The housing of claim 6, wherein the sheet of insulation extends farther down the first side than the panel.

8. The housing of claim 6, further comprising at least one cutout in a bottom of the sheet of insulation.

9. The housing of claim 6, wherein the panel comprises a paper.

10. The housing of claim 6, wherein the panel has a spontaneous open air combustion temperature between 350° F. and 500° F. (about 177° C. and 260° C.), inclusive.

11. The housing of claim 1, further comprising a first opening and a flap disposed over the first opening.

12. A method of insulating a ceiling can, comprising:
providing a housing having an insulated first side wall, an open bottom, and a tapered roof;
placing the housing over the can such that the first side wall is at least 3″ from the can; and
ensuring that the roof has at least a first opening for egress of hot air.

13. The method of claim 12, further comprising ensuring that the roof has an overhang over the first opening.

14. The method of claim 12, further comprising ensuring that all portions of the housing are at least 3″ from the can.

15. The method of claim 12, further comprising folding back a bottom portion of the first side wall.

16. The method of claim 15, wherein the ceiling can is disposed near a joist, and further comprising attaching the folded back bottom portion to the joist using a fastener.

17. The method of claim 12, wherein the ceiling can is disposed near a joist, and further comprising attaching the housing to the joist using a tie strip.

18. The method of claim 12, wherein the ceiling can is powered by a wire, and the first side wall defines a passage, and further comprising running the wire through the passage.

19. The method of claim 12, further comprising shipping the housing in a flattened shipping configuration.

20. The method of claim 12, further comprising disposing a blown type of insulation about the housing.
